(19) United States
(12) Patent Application Publication
(10) Pub. No.: US 2008/0156066 A1
(43) Pub. Date: Jul. 3, 2008

(54) Calibrating gauge for calibrating a vernier calliper

(76) Inventor: Johannes Jeromin, Nordlingen (DE)

Correspondence Address: PYLE & PIONTEK;ATTN: THOMAS R. VIGIL, 221 N LASALLE STREET , ROOM 2036, ROOM 2036, CHICAGO, IL, 60601, US

(21) Appl. No.: 12/075,579

(22) Filed: Mar. 12, 2008

(30) Foreign Application Priority Data
Sep. 15, 2005 (DE) 20 2005 014 635.8

(51) Int. Cl. G01B 3/42

(52) U.S. Cl. 73/1.81; 33/567

(57) ABSTRACT

The calibrating gauge for calibrating a Vernier calliper has at least one calibrating face for calibrating a measuring surface for internal measurement, at least one calibrating face for calibrating a measuring surface for external measurement (3) and at least one calibrating face for calibrating a measuring surface for depth measurement (4), the calibrating gauge (1) being in the shape of an at least partly hollow cylinder, on the generated surface (6) of which is provided the calibrating face for calibrating the measuring surface for the external measurement and on the inner surface (10) of which is provided the calibrating face for calibrating the measuring surface for the internal measurement, and the calibrating face for calibrating the measuring surface for the depth measurement being provided on at least one of the end faces (5) of the cylinder.

The present invention relates to a calibrating gauge for calibrating a vernier calliper.

Vernier callipers, which formerly were also called sliding callipers or slide gauges, are length-measuring instruments. For the measurement of external and internal dimensions the vernier calliper possesses two measuring surfaces in each case. In addition, vernier callipers usually have a further measuring surface for depth measurement. For the purpose of increasing the accuracy of reading, frequently a vernier or dial is provided on a vernier calliper. Electronic displays are also known for modern vernier callipers. In all vernier callipers, inaccuracies of measurement arise in the course of time, for example due to damage, contamination or slipping of the guide mechanisms. In order to rule out such errors of measurement, vernier callipers are calibrated with the aid of gauges. In order to guarantee a high accuracy of measurement, vernier callipers should be examined with a gauge before each measurement and, where appropriate, readjusted.

End gauges are known for the calibration of vernier callipers. In this case it is a question of small blocks which embody a certain length with a high accuracy. End gauges are consequently suitable for the calibration of the external measuring function of a vernier calliper. For the calibration of the internal measuring function, rings are known that have a defined internal diameter with a high degree of precision. For the calibration of the depth-measuring function there are, in turn, appropriate depth-calibrating gauges. The dimensions in calibrating gauges are usually specified accurately to at least two, frequently even three, decimal places. But these known calibrating gauges have the disadvantage that for each measuring function a separate calibrating gauge has to be used in each case. In practice, a calibration of vernier callipers is barely performed, since it is felt to be impractical to have a set of calibrating gauges in the region of the workbench, or to carry such a set on one's person.

A reference gauge for the purpose of calibrating measuring machines is known from US 2003/0106229 A1. In the case of such measuring machines, it is a question of measuring robots having a probe tip. In the case of the calibrating appliance that is presented, it is a question of a column that permits a height-measuring calibration. The invention provides that, in addition to the referencing in the vertical direction, a referencing is provided in the horizontal direction. Consequently the appliance described therein permits a calibration of two different dimensions, height and width, with a single reference gauge.

DE 694 08 305 T2 describes a measuring and calibrating tool that exhibits a number of reference surface projections. By reason of their arrangement in relation to one another, these form a number of measuring or calibrating distances that are to be suitable for the monitoring or measuring of appliances, both for internal measurement and for external measurement. The calibrating appliance is retained in a separate stand. It is comparatively large and, for this reason, not very easy to carry. Besides, only the calibration of the internal and external measuring device of a vernier calliper is possible therewith.

The object of the present invention is therefore to make available a calibrating gauge with which all the functions of a vernier calliper can be calibrated, and which is easy to handle and to carry.

This object is achieved by means of a calibrating gauge according to claim 1. Advantageous configurations are the subject-matter of the dependent claims.

The calibrating gauge according to the invention is suitable for calibrating a vernier calliper. The appropriate calibrating functions may, however, also be used for calibrating other measuring instruments, for example for calibrating a micrometer. The calibrating gauge can be appropriately adapted in its dimensions for this purpose.

In accordance with the invention, at least three calibrating surfaces are provided. The calibrating gauge exhibits at least one calibrating surface for calibrating a measuring surface for the internal measurement, at least one calibrating surface for calibrating a measuring surface for the external measurement, and at least one calibrating surface for calibrating a measuring surface for the depth measurement. For this purpose the calibrating gauge is designed in the manner of an at least partially hollow cylinder. At least a part of the internal surface in the hollow region of the cylinder is prepared as a calibrating surface for the internal measuring surface of the vernier calliper. At least one region of the circumferential surface of the cylinder is worked as a calibrating surface for the external measuring surface of the calibrating gauge. Finally, a calibrating surface for the depth-measuring surface is provided on at least one of the front sides of the cylinder. For this purpose, a depression is prepared in the front face. The surfaces of the respective calibrating surfaces are worked in highly precise manner, so that a statement of length can be made within the range of at least two—in particular, three—decimal places.

It is consequently advantageous that the calibrating gauge combines—in a single appliance—all the calibrating functions for calibrating all three measuring functions of a vernier calliper. Despite this multiple function, the calibrating gauge is of such compact construction overall that it can be kept in the region of the workbench. Dimensions are preferably chosen so that the calibrating gauge can be accommodated in the trouser pocket of work trousers such as are usually worn by mechanics in the course of their work.

The invention will be elucidated and described in greater detail in the following on the basis of the drawings.

Shown are:

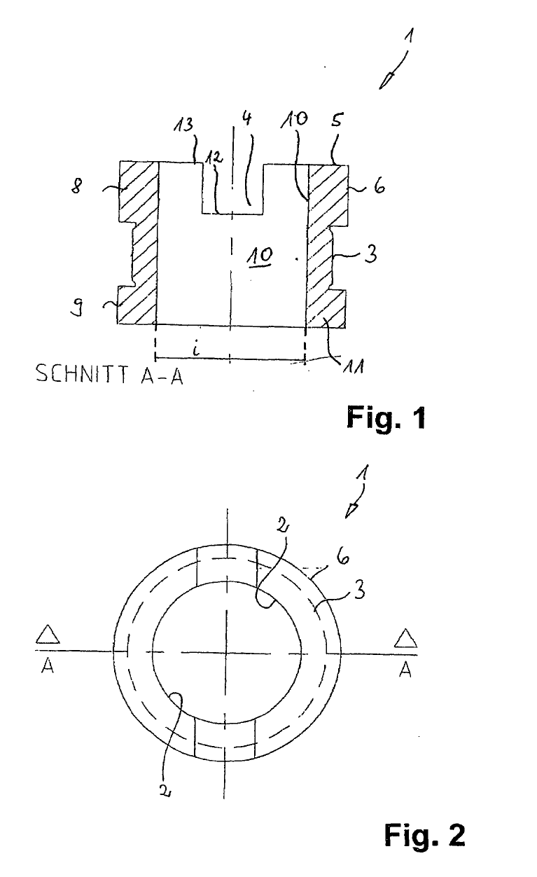

FIG. 1: a side view of a calibrating gauge according to the invention;

FIG. 2: a top view of the calibrating gauge of FIG. 1;

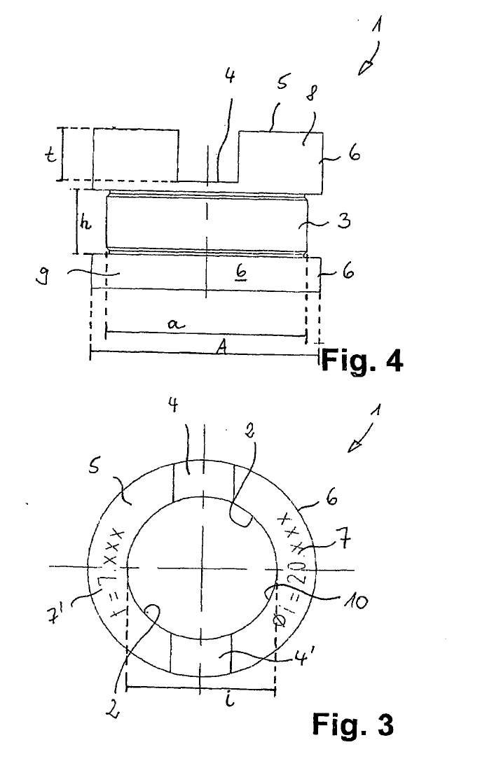

FIG. 3: a top view of the calibrating gauge of FIG. 1, in which structures situated lower down have been introduced;

FIG. 4: a section through the calibrating gauge according to the invention along line A-A in FIG. 2;

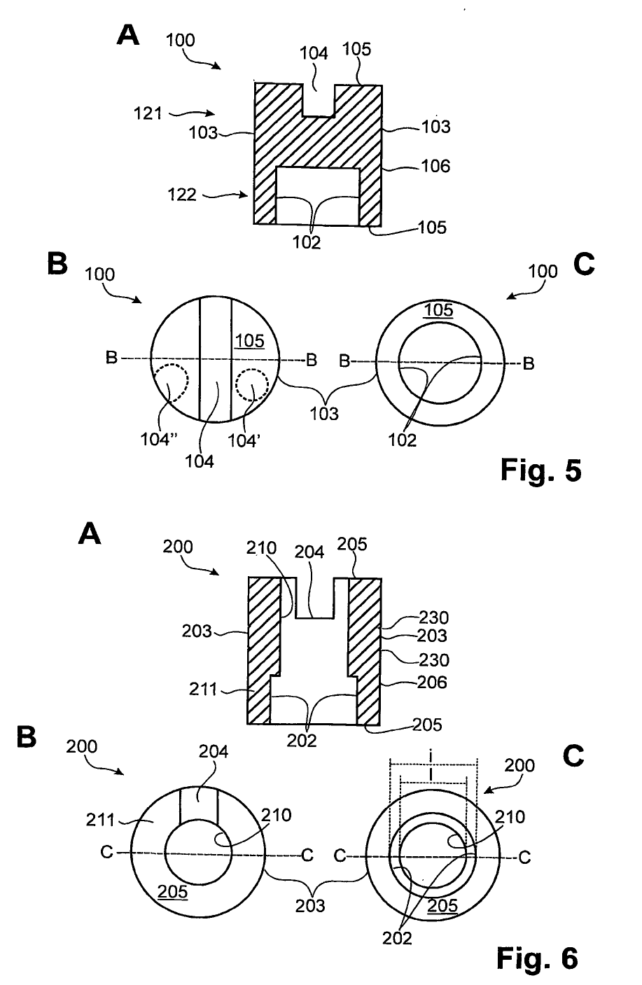

FIG. 5: a second exemplary embodiment of a calibrating gauge according to the invention, in section (A), in top view (B) and in bottom view (C); and

FIG. 6: yet another exemplary embodiment of a calibrating gauge according to the invention, in section (A), in top view (B) and in bottom view (C).

FIGS. 1 to 4 show a first exemplary embodiment of a calibrating gauge according to the invention. The calibrating gauge 1 has a cylindrical shape overall. In the embodiment shown in FIGS. 1 to 4, it is a question of a hollow cylinder. The calibrating gauge 1 exhibits a calibrating surface for calibrating a measuring surface for the internal measurement 2. In the following, this calibrating surface will also be designated for short as the internal-measurement calibrating surface 2. The calibrating gauge 1 further exhibits a calibrating surface for calibrating a measuring surface for the external measurement 3, in the following also designated for short as the external-measurement calibrating surface 3. Finally, a calibrating surface is provided for calibrating a measuring surface for the depth measurement 4, the depth-measurement calibrating surface 4 for short.

The calibration of the measuring surface for the external measurement of a vernier calliper is undertaken by encompassing the external-measurement calibrating surface 3 so that the outside diameter a is measured. The exact value of a, and hence of the external-measurement calibrating surface 3, is specified on the calibrating gauge 1, as indicated by the inscription 7″. In the embodiment shown in FIGS. 1 to 4, the external-measurement calibrating surface 3 is sunk deep into the circumferential surface 6 of the cylinder; this means that the diameter a is smaller than the outside diameter A of the cylinder. This is particularly advantageous, since by means of this measure the parallel application of the measuring surfaces for the external measurement of a vernier calliper is facilitated. Inaccuracies of measurement are reduced in this way. The height h of this deepened external-measurement calibrating surface 3 is preferably such that the calibrating gauge 1 can also be used for calibrating a micrometer. A conventional dimension, which is suitable for the calibration of micrometers, is a height h of at least 9 mm.

The internal-measurement calibrating surface 2 is formed by the internal surface 10 of the hollow cylinder of the calibrating gauge 1. What is measured in this case is the internal diameter i of the calibrating gauge 1. The exact value of i is specified as an inscription 7 on the calibrating gauge 1, for example on the front side 5 of the calibrating gauge.

Moreover, the depth-measurement calibrating surfaces 4 are worked into the front sides 5 of the cylinder. The invention provides that at least one depth-measurement calibrating surface 4 is provided on a calibrating gauge 1 according to the invention. Preferably, however, several depth-measurement calibrating gauges 4 are provided. In the exemplary embodiment shown in FIGS. 1 to 4, two depth-measurement calibrating surfaces 4 and 4′ are provided. The depth-measurement calibrating surfaces 4 and 4′ are preferably situated opposite one another in alignment. In the case of the depth-measurement calibrating surface 4, it is a question of an indentation into the wall 11 of the cylinder of the calibrating gauge 1. The depth t of the indentation defines the unit of measurement with which the depth-measuring calibration is performed. The value of t is again specified on the calibrating gauge 1—in the exemplary embodiment shown in FIGS. 1 to 4, on the front side 5 in the form of an inscription 7′.

It becomes evident from FIGS. 1 and 4 that the internal surface 10 of the cylinder is designed in such a way that the inside diameter i of the hollow cylinder is constant over the entire height of the calibrating gauge 1. Furthermore, it is evident in FIGS. 1 and 4 that the external-measurement calibrating surface 3 is bounded by two rings bounding this surface, which are parallel to one another. The boundary rings 8 and 9 may exhibit either different heights or approximately the same heights. In the exemplary embodiment shown in FIGS. 1 to 4 the height of boundary ring 8 is greater than the height of boundary ring 9. The depth-measurement calibrating surface 4 is preferably formed in the wall 11 in the region of boundary ring 8, said surface extending over virtually the entire height of boundary ring 8. The wall 11 found there, which is thicker in comparison with the region of the external-measurement calibrating surface 3, consequently offers the advantage that the depth-measurement calibrating surface 4 exhibits an appropriately wider contact surface 12 on the bottom of the depth-measurement calibrating surface and an appropriately wide contact surface 13 on the front side 5 for the purpose of placing the vernier calliper on top in the course of the calibration.

FIG. 5 shows a further exemplary embodiment of a calibrating gauge 100. FIG. 5A shows a section along line B-B in FIGS. 5B and 5C. The calibrating gauge 100 once again exhibits three calibrating surfaces, namely the calibrating surface for calibrating a measuring surface for the internal measurement 102, the calibrating surface for the calibration of a measuring surface for the external measurement 103, and a calibrating surface for calibrating a measuring surface for the depth measurement 104. The external-measurement calibrating surface 103 extends over the entire circumferential surface 106 of the calibrating gauge 100.

In contrast to the embodiment shown in FIGS. 1 to 4, the calibrating gauge 100 is of partially solid design. This means that a solid region 121 and a hollow region 122 are provided. The internal-measurement calibrating surface 102 is formed in the hollow region 122. For the calibration, the hollow region 122 is consequently entered with the measuring surface for the internal measurement of a vernier calliper, and the internal diameter of this region is measured. The external-measurement calibrating surface 103 is provided on the entire circumferential surface 106 of the calibrating gauge 100; it extends over the entire height of the cylinder.

The depth-measurement calibrating surface 104 is once again countersunk into one of the front sides 105 of the cylinder. In the case of the embodiment shown in FIG. 5, an appropriate indentation has been made in the solid region 121. In principle, the depth-measurement calibrating surface 104 may also exhibit the form of a recess, as indicated in FIG. 5B, for example, by the dashed depth-measurement calibrating surfaces 104′ and 104″. The location of the depth-measurement calibrating surfaces 104, 104′ and 104″ on the front side 105 of the calibrating gauge 100 is of subordinate importance. They may be arranged both centrally and eccentrically. On the calibrating gauge 100, inscriptions are once again provided which, however, have not been represented.

Lastly, FIG. 6 shows yet another exemplary embodiment of a calibrating gauge 200 according to the invention. FIG. 6A shows a section along line C-C in FIGS. 6B and 6C. In the case of the calibrating gauge 200, it is a question of a hollow cylindrical calibrating gauge. The external-measurement calibrating surface 203 is once again provided on the circumferential surface 206, whereby the external-measurement calibrating surface—differently from that in the exemplary embodiment shown in FIG. 5—does not extend over the entire height, and hence over the entire circumferential surface of the cylinder, but is limited to a certain region. This region can be visually emphasised, for example by means of two peripheral grooves 230.

In the embodiment shown in FIG. 6 the internal-measurement calibrating surface 202 is sunk deep into the wall 211. This means that the inside diameter i of the internal-measurement calibrating surface 202 is greater than the inside diameter I of the cylinder, which is bounded by the internal surface 210. This affords the advantage that in the course of production of the calibrating gauge 200 merely a region of the internal surface has to be worked and treated in appropriately exact manner in order to provide the requisite accuracy of measurement. In the exemplary embodiment shown in FIG. 6, a depth-measurement calibrating surface 204 is provided which, corresponding to the embodiment in FIGS. 1 and 4, is formed in the wall 211 on one of the front sides 205 in the form of an appropriate indentation.

List of Reference Symbols

| | |
|---|---|
| 1, 100, 200 | calibrating gauge |
| 2, 102, 202 | calibrating surface for calibrating a |
| | measuring surface for the internal |
| | measurement |
| 3, 103, 203 | calibrating surface for calibrating a |
| | measuring surface for the external |
| | measurement |
| 4, 104, 204 | calibrating surface for calibrating a |
| | measuring surface for the depth measurement |
| 5, 105, 205 | front side |
| 6, 106, 206 | circumferential surface |
| 7 | inscription |
| 8 | boundary ring |
| 9 | boundary ring |
| 10, 210 | internal surface |
| 11, 211 | wall |
| 12 | contact surface |
| 13 | contact surface |
| 121 | solid region |
| 122 | hollow region |
| 230 | grooves |

1. Calibrating gauge for calibrating a vernier calliper, characterised in that at least one calibrating surface for calibrating a measuring surface for the internal measurement at least one calibrating surface for calibrating a measuring surface for the external measurement and at least one calibrating surface for calibrating a measuring surface for the depth measurement are provided thereon, whereby the calibrating gauge has the form of an at least partially hollow cylinder, on the circumferential surface of which the calibrating surface for calibrating the measuring surface for the external measurement is provided, and on the internal surface of which the calibrating surface for calibrating the measuring surface for the internal measurement is provided, and whereby on at least one of the front sides of the cylinder the calibrating surface for calibrating the measuring surface for the depth measurement is provided.

2 Calibrating gauge according to claim 1, characterised in that the calibrating surface for calibrating the measuring surface for the external measurement is sunk deep into the circumferential surface of the cylinder, so that the diameter of this calibrating surface is smaller than the outside diameter of the cylinder.

3. Calibrating gauge according to claim 2, characterised in that the height of the calibrating surface for calibrating the measuring surface for the external measurement is adapted in such a way that the calibrating gauge can be used for calibrating a micrometer, in particular in that the height of this calibrating surface amounts to at least 9 mm.

4. Calibrating gauge according to claim 1, characterised in that the calibrating surface for calibrating the measuring surface for the depth measurement is at least one indentation on the front side of the cylinder are, whereby the height of a wall of the cylinder adjacent to this indentation specifies the depth to be calibrated.

5. Calibrating gauge according to claim 1, characterised in that the calibrating surface for calibrating the measuring surface for the internal measurement is sunk deep into the internal surface of the cylinder, so that the diameter of this calibrating surface is greater than the internal diameter of the cylinder.

6. Calibrating gauge according to claim 1 characterised in that the calibrating surface for calibrating the measuring surface for the depth measurement in the case of a calibrating gauge which only partially takes the form of a hollow cylinder is provided in a solid region of the cylinder.

7. Calibrating gauge according to claim 1, characterised in that the calibrating gauge is a hollow cylinder.

8. Calibrating gauge according to claim 7, characterised in that the inside diameter of the hollow cylinder is constant over the entire height of the cylinder.

9. Calibrating gauge according to claim 1 characterised in that the calibrating surface for calibrating the measuring surface for the external measurement is bounded by two parallel boundary rings.

10. Calibrating gauge according to claim 9, characterised in that the heights of the boundary rings differ from one another.

11. Calibrating gauge according to claim 9, characterised in that the calibrating surface for calibrating the measuring surface for the depth measurement is formed over virtually the entire height of one of the two boundary rings.

12. Calibrating gauge according to claim 1, characterised in that the calibrating surface for calibrating the measuring surface for the external measurement is bounded by two parallel peripheral grooves.

13. Calibrating gauge according to claim 1, characterised in that two calibrating surfaces for calibrating the measuring surface for the depth measurement are provided, which are arranged, in particular in alignment with one another.

14. Calibrating gauge according to claim 10, characterised in that the calibrating surface for calibrating the measuring surface for the depth measurement is formed over virtually the entire height of one of the two boundary rings.
